(19) United States
(12) Patent Application Publication
(10) Pub. No.: US 2022/0365819 A1
(43) Pub. Date: Nov. 17, 2022

(54) LOAD BALANCING SYSTEM, LOAD BALANCING DEVICE, LOAD BALANCING METHOD, AND COMPUTER-READABLE MEDIUM

(71) Applicant: NEC Corporation, Minato-ku, Tokyo (JP)

(72) Inventors: Takeshi ARIKUMA, Tokyo (JP); Takatoshi KITANO, Tokyo (JP)

(73) Assignee: NEC Corporation, Minato-ku, Tokyo (JP)

(21) Appl. No.: 17/770,732

(22) PCT Filed: Nov. 6, 2019
(86) PCT No.: PCT/JP2019/043476

§ 371 Date: Apr. 21, 2022

(51) Int. Cl. G06F 9/50

(52) U.S. Cl. CPC G06F 9/505; G06F 9/5038; G06F 9/5072

(57) ABSTRACT

A load balancing system (1) according to the present disclosure includes a processing unit (10-1), a processing unit (10-2) that processes a processing result of the processing unit (10-1), a processing unit (10-3) that processes a processing result of the processing unit (10-2), a resource management unit (20-1), a resource management unit (20-2), and a resource management unit (20-3). When the resource management unit (20-2) detects an occurrence of an overload in the processing unit (10-2), the resource management unit (20-2) starts to add a resource of the processing unit (10-2), the resource management unit (20-3) starts to add a resource of the processing unit (10-3), and the resource management unit (20-1) starts to suppress throughput of the processing unit (10-1). When it is completed to add resources of the processing units (10-2) and (10-3), the resource management unit (20-1) cancels suppression of throughput of the processing unit (10-1).

### TECHNICAL FIELD

The present disclosure relates to a load balancing system, a load balancing device, a load balancing method, and a computer-readable medium.

### BACKGROUND ART

In recent years, in a field of video recognition, recognition targets and application locations are diversifying, and accordingly, there is a need to flexibly apply changes and expansion to the system, such as addition of a function and expansion in the number of cameras. In order to satisfy this need, a system referred to as a microservice architecture, in which a process of a system is distributed to a plurality of processes and the plurality of processes are loosely coupled, is attracting attention.

In the system in which a plurality of processes are loosely coupled, each of the plurality of processes sequentially processes processing results of upstream stages. For example, in a case of a video recognition system, a plurality of processes such as a video acquisition process, an object detection process, and an object collation process are loosely coupled for establishing a system.

In this case, as a method for improving processing performance of each process, there is a method referred to as “scale-out” for increasing resources of an associated process. An example of a related technique for performing scale-out of resources includes a technique disclosed in Patent Literature 1.

According to the technique disclosed in Patent Literature 1, in a case where a server device tends to be overloaded, and security violations do not tend to increase at a time of execution of information processing by the server device, the server device is scaled out.

### CITATION LIST

### Non Patent Literature

Non-Patent Literature 1: Japanese Unexamined Patent Application Publication No. 2015-219753

### SUMMARY OF INVENTION

### Technical Problem

However, in a case where the technique disclosed in Patent Literature 1 is applied to the system in which a plurality of processes are loosely coupled, when resources for a process of a target stage are increased in response to an occurrence of overload in the process of the target stage, a load of processes of downstream stages rapidly increases. As a result, in a case where the processing target is a video or the like with a large data size, an overload may occur in the processes of downstream stages.

Accordingly, an object of the present disclosure is to solve the above-described problem, and to provide a load balancing system, a load balancing device, a load balancing method, and a computer-readable medium that are capable of achieving scale-out of resources of the target stage, without causing an overload in downstream stages.

### Solution to Problem

A load balancing system according to one aspect includes:

a first processing unit;

a second processing unit configured to process a processing result of the first processing unit;

a third processing unit configured to process a processing result of the second processing unit;

a first resource management unit configured to manage a resource of the first processing unit;

a second resource management unit configured to manage a resource of the second processing unit; and

a third resource management unit configured to manage a resource of the third processing unit, wherein

the second resource management unit detects whether an overload occurs in the second processing unit, and in a case where the second resource management unit detects that an overload has occurred in the second processing unit, the second resource management unit starts to add a resource of the second processing unit,

in a case where the second resource management unit detects that an overload has occurred in the second processing unit, the third resource management unit starts to add a resource of the third processing unit,

in a case where the second resource management unit detects that an overload has occurred in the second processing unit, the first resource management unit starts to suppress throughput of the first processing unit, and,

in a case where it is completed to add resources of the second processing unit and the third processing unit, the first resource management unit cancels suppression of throughput of the first processing unit.

A load balancing device according to one aspect includes:

a first processing unit;

a second processing unit configured to process a processing result of the first processing unit;

a third processing unit configured to process a processing result of the second processing unit;

a first resource management unit configured to manage a resource of the first processing unit;

a second resource management unit configured to manage a resource of the second processing unit; and

a third resource management unit configured to manage a resource of the third processing unit, wherein

the second resource management unit detects whether an overload occurs in the second processing unit, and in a case where the second resource management unit detects that an overload has occurred in the second processing unit, the second resource management unit starts to add a resource of the second processing unit,

in a case where the second resource management unit detects that an overload has occurred in the second processing unit, the third resource management unit starts to add a resource of the third processing unit,

in a case where the second resource management unit detects that an overload has occurred in the second processing unit, the first resource management unit starts to suppress throughput of the first processing unit, and,

in a case where it is completed to add resources of the second processing unit and the third processing unit, the first resource management unit cancels suppression of throughput of the first processing unit.

A load balancing method according to one aspect is a load balancing method being performed by a load balancing device including a first processing unit, a second processing unit configured to process a processing result of the first processing unit, and a third processing unit configured to process a processing result of the second processing unit, the load balancing method including:

a first step of detecting whether an overload occurs in the second processing unit;

a second step of, in a case where an occurrence of an overload is detected in the second processing unit, starting to add resources of the second processing unit and the third processing unit and starting to suppress throughput of the first processing unit, and

a third step of, in a case where it is completed to add resources of the second processing unit and the third processing unit, canceling suppression of throughput of the first processing unit.

A computer-readable medium according to one aspect is a non-transitory computer-readable medium storing a load balancing program configured to cause a computer including a first processing unit, a second processing unit configured to process a processing result of the first processing unit, and a third processing unit configured to process a processing result of the second processing unit, to execute:

a first procedure of detecting whether an overload occurs in the second processing unit;

a second procedure of, in a case where an occurrence of an overload has been detected in the second processing unit, starting to add resources of the second processing unit and the third processing unit and starting to suppress throughput of the first processing unit, and

a third procedure of, in a case where it is completed to add resources of the second processing unit and the third processing unit, canceling suppression of throughput of the first processing unit.

### Advantageous Effects of Invention

According to the above-described aspects, an effect of being able to provide a load balancing system, a load balancing device, a load balancing method, and a computer-readable medium that are capable of achieving scale-out of a resource of a target stage, without causing an overload in downstream stages, can be acquired.

### BRIEF DESCRIPTION OF THE DRAWINGS

FIG. 1 is a block diagram illustrating an example of configuration of a load balancing system according to an overview of an example embodiment.

FIG. 2 is a diagram illustrating an example of operation of a load balancing system according to an overview of the example embodiment.

FIG. 3 is a block diagram illustrating an example of configuration of the load balancing system according to the example embodiment.

FIG. 4 is a flowchart illustrating an example of a resource increase process that is performed in a case where an overload occurs in any one of a plurality of processing units in the load balancing system according to the example embodiment.

FIG. 5 is a flowchart illustrating an example of a throughput control start process of step S202 of FIG. 4.

FIG. 6 is a flowchart illustrating an example of a throughput control cancellation process of step S209 of FIG. 4.

FIG. 7 is a flowchart illustrating an example of a resource adjustment process of step S206 of FIG. 4.

FIG. 8 is a block diagram illustrating an example of configuration of a load balancing system according to a specific example of the example embodiment.

FIG. 9 is a figure illustrating an example of video acquired by a video acquisition processing unit according to the specific example of the example embodiment.

FIG. 10 is a timing chart illustrating an example of operation of the load balancing system according to the specific example of the example embodiment.

FIG. 11 is a block diagram illustrating an example of hardware configuration of a computer that achieves the load balancing system according to the example embodiment.

### DESCRIPTION OF EMBODIMENTS

Hereinafter, an example embodiment of the present disclosure will be described in detail with reference to the drawings. In the following description and drawings, omissions and simplifications are made as appropriate for the sake of clarification of the explanation. Furthermore, in the drawings below, the same elements are denoted with the same reference numerals, and duplicate explanation thereabout is omitted as necessary. Also, specific numerical values shown in the following example embodiment are merely examples for facilitating understanding of the present disclosure, and are not limited thereto.

### Overview of Example Embodiment

Before the present example embodiment is explained, an overview of the present example embodiment is explained.

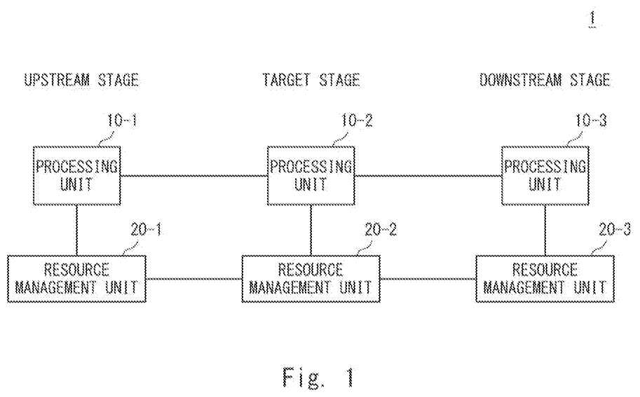

First, an example of configuration of a load balancing system 1 according to an overview of the present example embodiment is explained with reference to FIG. 1.

As illustrated in FIG. 1, the load balancing system 1 according to an overview of the present example embodiment includes processing units 10-1 to 10-3 loosely coupled with each other and resource management units 20-1 to 20-3. Hereinafter, in a case where the processing units 10-1 to 10-3 are referred to without being distinguished from each other in particular, the processing units 10-1 to 10-3 may be simply referred to as a “processing unit 10”. Likewise, the resource management units 20-1 to 20-3 may be simply referred to as a “resource management unit 20”. FIG. 1 is an example in which three processing units 10-1 to 10-3 are loosely coupled, i.e., an example in which the number of stages of processes is three, but the number of stages of processes may be three or more.

The processing unit 10-2 processes the processing result of the processing unit 10-1.

The processing unit 10-3 processes the processing result of the processing unit 10-2.

The processing units 10-1 to 10-3 includes buffers, not illustrated, to temporarily store process targets in the buffers and thereafter perform processes of the process targets. However, the buffer is not limited to being provided in the processing unit 10, and may be provided in the upstream stage of the processing unit 10.

The resource management unit 20-1 manages the resource of the processing unit 10-1.

The resource management unit 20-2 manages the resource of the processing unit 10-2.

The resource management unit 20-3 manages the resource of the processing unit 10-3.

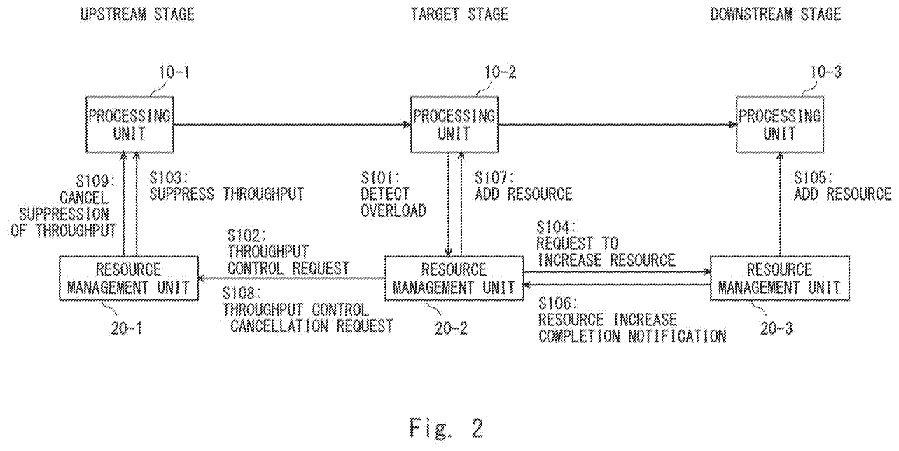

Next, with reference to FIG. 2, an example of operation of the load balancing system 1 according to an overview of the present example embodiment is explained.

As illustrated in FIG. 2, it is assumed that the resource management unit 20-2 has detected an occurrence of an overload in the processing unit 10-2 (step S101).

Therefore, the resource management unit 20-2 transmits, to the resource management unit 20-1, a throughput control request for requesting to suppress the throughput of the processing unit 10-1 (i.e., to control the throughput of the processing unit 10-1) (step S102). In a case where the resource management unit 20-1 receives the throughput control request from the resource management unit 20-2, the resource management unit 20-1 starts to suppress the throughput of the processing unit 10-1 (step S103). For example, the resource management unit 20-1 reduces the process speed of the processing unit 10-1.

Also, the resource management unit 20-2 transmits, to the resource management unit 20-3, a resource increase request for requesting to increase the resource of the processing unit 10-3 (step S104). In a case where the resource management unit 20-3 receives a resource increase request from the resource management unit 20-2, the resource management unit 20-3 starts to increase the resource of the processing unit 10-3 (step S105). In a case where the increase of the resource of the processing unit 10-3 is completed, the resource management unit 20-3 transmits, to the resource management unit 20-2, a resource increase completion notification for notifying that the increase of the resource of the processing unit 10-3 is completed (step S106).

Also, the resource management unit 20-2 starts to increase the resource of the processing unit 10-2 (step S107).

In a case where the increase of the resource of the processing unit 10-2 is completed, and the resource management unit 20-2 receives the resource increase completion notification from the resource management unit 20-3, the resource management unit 20-2 transmits, to resource management unit 20-1, a throughput control cancellation request for requesting to cancel suppression of the throughput of the processing unit 10-1 (i.e., to cancel the throughput control of the processing unit 10-1) (step S108). In a case where the resource management unit 20-1 receives a throughput control cancellation request from the resource management unit 20-2, the resource management unit 20-1 cancels suppression of the throughput of the processing unit 10-1 (step S109). For example, the resource management unit 20-1 returns the process speed of the processing unit 10-1 to the default process speed.

In the example of FIG. 2, before the increase of the resources of the processing units 10-2, 10-3 is started, the suppression of the throughput of the processing unit 10-1 is started, but the example embodiment is not limited thereto. For example, the increase of the resources of the processing units 10-2, 10-3 and the suppression of the throughput of the processing unit 10-1 may be started at the same time. Alternatively, after the increase of the resources of the processing units 10-2, 10-3 is started, the suppression of the throughput of the processing unit 10-1 may be started.

As described above, with the load balancing system 1 according to an overview of the present example embodiment, in a case where an occurrence of an overload in the processing unit 10-2 of the target stage is detected, the resources of not only the processing unit 10-2 of the target stage but also the processing unit 10-3 of the downstream stage are started to be increased, and the throughput of the processing unit 10-1 of the upstream stage is suppressed until the increase of the resources of the processing unit 10-2 of the target stage and the processing unit 10-3 of the downstream stage is completed.

Therefore, in a case where an overload occurs in the processing unit 10-2 of the target stage, scale-out of the resource of the processing unit 10-2 of the target stage can be achieved without causing an overload in the processing unit 10-3 of the downstream stage.

In addition, even when the resource of the processing unit 10-2 of the target stage is scaled out, loose coupling of the three processing units 10-1 to 10-3 can be maintained, and therefore, the range of system that is to be changed due to scale-out can be kept to a minimum.

It is to be noted that, in the load balancing system 1 according to an overview of the present example embodiment, in a case where an occurrence of an overload occurs in the processing unit 10-2 is detected, not only the resource of the processing unit 10-2 but also the resource of the processing unit 10-3 increase. However, even when the resource of the processing unit 10-2 increases, an overload does not necessarily occur in the processing unit 10-3. If the resource of the processing unit 10-3 is increased even in such a case, there occurs a problem in that, e.g., the increased resource is wasted or the resource efficiency decreases.

Therefore, in a case where the resource management unit 20-2 detects an occurrence of an overload in the processing unit 10-2, the resource management unit 20-2 may determine whether there is a possibility that an overload occurs in the processing unit 10-3 of the downstream stage due to addition of a resource of the processing unit 10-2. Then, in a case where the resource management unit 20-2 determines that there is a possibility that an overload occurs in the processing unit 10-3 of the downstream stage, the resource management unit 20-2 may determines to increase the resource of the processing unit 10-3, and may transmit a resource increase request to the resource management unit 20-3.

### Example Embodiment

Next, the present example embodiment is explained.

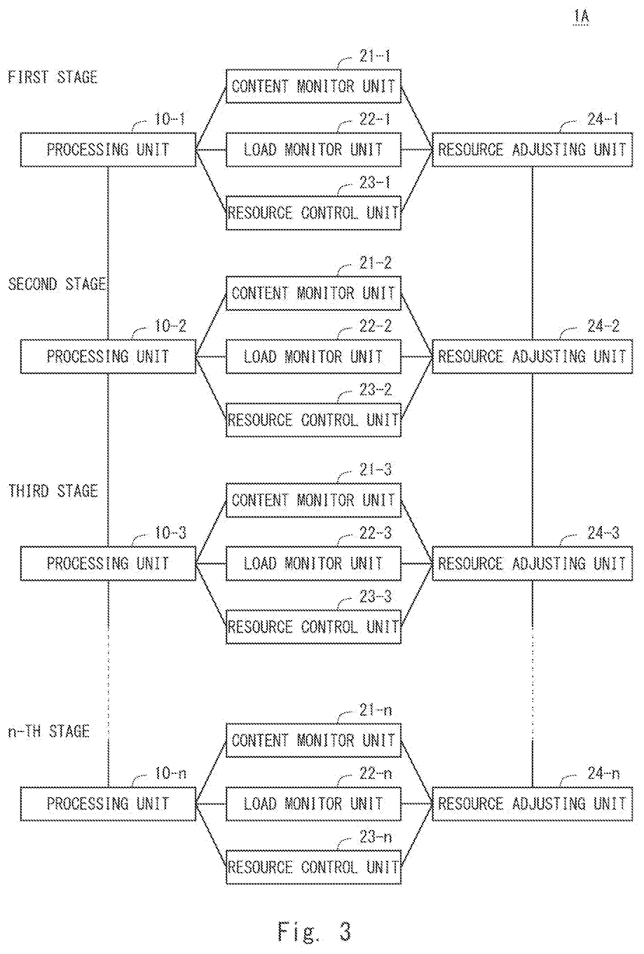

First, an example of configuration of a load balancing system 1A according to the present example embodiment is explained with reference to FIG. 3.

As illustrated in FIG. 3, the load balancing system 1A according to the present example embodiment includes processing units 10-1 to 10-n (n is an integer that is equal to or more than 3) that are loosely coupled with each other, content monitor units 21-1 to 21-n, load monitor units 22-1 to 22-n, resource control units 23-1 to 23-n, and resource adjusting units 24-1 to 24-n. Hereinafter, in a case where the content monitor units 21-1 to 21-n are referred to without being distinguished from each other in particular, the content monitor units 21-1 to 21-n may be simply referred to as a “content monitor unit 21”. The load monitor units 22-1 to 22-n may be simply referred to as a “load monitor unit 22”, the resource control units 23-1 to 23-n may be simply referred to as a “resource control unit 23”, and the resource adjusting units 24-1 to 24-n may be simply referred to as a “resource adjusting unit 24”. A configuration constituted by the content monitor unit 21, the load monitor unit 22, the resource control unit 23, and the resource adjusting unit 24 corresponds to the resource management unit 20 of FIG. 1.

For example, the processing unit 10 performs an analysis process on a video or on an analysis process result of a video by the processing unit 10 of the upstream stage, and outputs an analysis process result to the processing unit 10 of the downstream stage.

The content monitor unit 21 monitors a processing content of the processing unit 10 of the self-stage, and outputs a monitor result to the resource adjusting unit 24 of the self-stage.

The load monitor unit 22 monitors a processing load of the processing unit 10 of the self-stage, and outputs a monitor result to the resource adjusting unit 24 of the self-stage.

The resource control unit 23 increases or decreases the throughput and increases or decreases the resource of the processing unit 10 of the self-stage under the control of the resource adjusting unit 24 of the self-stage.

The resource adjusting unit 24 acquires a monitor result of a processing load of the processing unit 10 of the self-stage from the load monitor unit 22 of the self-stage. Furthermore, the resource adjusting unit 24 detects whether an overload occurs in the processing unit 10 of the self-stage on the basis of the processing load of the processing unit 10 of the self-stage.

In a case where the resource adjusting unit 24 detects an occurrence of an overload in the processing unit 10 of the self-stage, the resource adjusting unit 24 transmits a throughput control request to the resource adjusting unit 24 of the upstream stage. Furthermore, the resource adjusting unit 24 starts to increase the resource of the processing unit 10 of the self-stage by controlling the resource control unit 23 of the self-stage.

In a case where the resource adjusting unit 24 detects an occurrence of an overload in the processing unit 10 of the self-stage, the resource adjusting unit 24 acquires a processing content and a monitor result of the processing load of the processing unit 10 of the self-stage from the content monitor unit 21 and the load monitor unit 22 of the self-stage, and acquires the monitor result of the processing load of the processing unit 10 of the downstream stage from the load monitor unit 22 of the downstream stage via the resource adjusting unit 24 of the downstream stage. Then, the resource adjusting unit 24 determines whether there is a possibility that an overload occurs in the processing unit 10 of the downstream stage due to addition of a resource of the processing unit 10 of the self-stage on the basis of the processing content and the processing load of the processing unit 10 of the self-stage and the processing load of the processing unit 10 of the downstream stage.

In a case where the resource adjusting unit 24 determines that there is a possibility that an overload occurs in the processing unit 10 of the downstream stage, the resource adjusting unit 24 transmits a resource increase request to the resource adjusting unit 24 of the downstream stage.

In a case where the resource adjusting unit 24 receives the resource increase request from the resource adjusting unit 24 of the upstream stage, the resource adjusting unit 24 starts to increase the resource of the processing unit 10 of the self-stage by controlling the resource control unit 23 of the self-stage. Furthermore, in a case where the increase of the resource of the processing unit 10 of the self-stage is completed, the resource adjusting unit 24 transmits a resource increase completion notification to the resource adjusting unit 24 of the upstream stage.

In a case where the increase of the resource of the processing unit 10 of the self-stage is completed or in a case where the increase of the resource of the processing unit 10 of the self-stage is completed and the resource adjusting unit 24 has received a resource increase completion notification from the resource adjusting unit 24 of the downstream stage, the resource adjusting unit 24 transmits a throughput control cancellation request to the resource adjusting unit 24 of the upstream stage.

In a case where the resource adjusting unit 24 receives a throughput control request from the resource adjusting unit 24 of the downstream stage, the resource adjusting unit 24 starts to suppress the throughput of the processing unit 10 of the self-stage by controlling the resource control unit 23 of the self-stage. In a case where the resource adjusting unit 24 receives the throughput control cancellation request from the resource adjusting unit 24 of the downstream stage, the resource adjusting unit 24 cancels the suppression of the throughput of the processing unit 10 of the self-stage by controlling the resource control unit 23 of the self-stage.

In a case where the resource of the processing unit 10 of the self-stage is to be increased, the resource adjusting unit 24 may determine the timing for increasing the resource of the processing unit 10 of the self-stage and the quantity of resource to be increased, on the basis of the processing content and the processing load of the processing unit 10 of the self-stage. Then, the resource adjusting unit 24 may add the determined quantity of resource to the processing unit 10 of the self-stage at the determined timing.

In a case where the resource of the processing unit 10 of the downstream stage is to be increased, the resource adjusting unit 24 may determine the timing for increasing the resource of the processing unit 10 of the downstream stage and the quantity of resource to be increased, on the basis of the processing content and the processing load of the processing unit 10 of the downstream stage. Furthermore, in the resource increase request transmitted to the resource adjusting unit 24 of the downstream stage, the resource adjusting unit 24 may request to add the determined quantity of resource to the processing unit 10 of the downstream stage at the determined timing.

In a case where the resource adjusting unit 24-1 of the most upstream stage detects an occurrence of an overload in the processing unit 10-1 of the self-stage, transmission of a throughput control request and a throughput control cancellation request is omitted. Other than the above, the resource adjusting unit 24-1 may perform substantially the same operation as other resource adjusting units 24.

In a case where the resource adjusting unit 24-n of the most downstream stage detects an occurrence of an overload in the processing unit 10-n of the self-stage, determination as to an overload of the processing unit 10 of the downstream stage and transmission of a resource increase request are omitted. Other than the above, the resource adjusting unit 24-n may perform substantially the same operation as other resource adjusting units 24.

Next, an example of an operation of the load balancing system 1A according to the present example embodiment is explained.

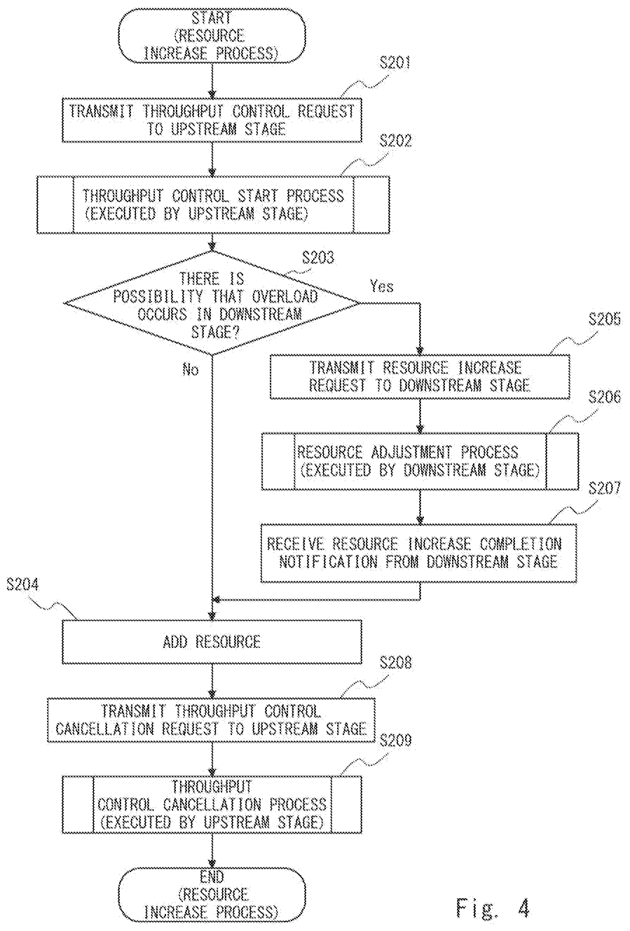

First, an example of a resource increase process performed in a case where an overload occurs in any one of the processing units 10-1 to 10-n is explained with reference to FIG. 4. Hereinafter, an example of a resource increase process is explained that is performed in a case where an overload occurs in the processing unit 10-2.

As illustrated in FIG. 4, when the resource adjusting unit 24-2 detects an occurrence of an overload in the processing unit 10-2, the resource adjusting unit 24-2 transmits a throughput control request to the resource adjusting unit 24-1 of the upstream stage (step S201). In response, the resource adjusting unit 24-1 performs a throughput control start process (step S202). The throughput control start process is explained later.

Next, the resource adjusting unit 24-2 determines whether there is a possibility that an overload occurs in the processing unit 10-3 of the downstream stage due to addition of a resource of the processing unit 10-2 (step S203).

In step S203, in a case where there is no possibility that an overload occurs in the processing unit 10-3 of the downstream stage (No in step S203), the resource adjusting unit 24-2 starts to increase the resource of the processing unit 10-2 by controlling the resource control unit 23-2 (step S204).

In contrast, in step S203, in a case where there is a possibility that an overload occurs in the processing unit 10-3 of the downstream stage (Yes in step S203), the resource adjusting unit 24-2 transmits a resource increase request to the resource adjusting unit 24-3 of the downstream stage (step S205). In response, the resource adjusting unit 24-3 performs a resource adjustment process (step S206). The resource adjustment process is explained later. Thereafter, the resource adjusting unit 24-2 in on standby until the resource adjusting unit 24-2 receives a resource increase completion notification from the resource adjusting unit 24-3 of the downstream stage (step S207). When the resource adjusting unit 24-2 receives the resource increase completion notification from the resource adjusting unit 24-3 of the downstream stage, the resource adjusting unit 24-2 starts to increase the resource of the processing unit 10-2 by controlling the resource control unit 23-2 (step S204). However, the example embodiment is not limited thereto. The resource adjusting unit 24-2 may start to increase the resource of the processing unit 10-2 without waiting for the resource increase completion notification from the resource adjusting unit 24-3 of the downstream stage.

In a case where the increase of the resource of the processing unit 10-2 is completed or in a case where the increase of the resource of the processing unit 10-2 is completed and the resource adjusting unit 24-2 has received a resource increase completion notification from the resource adjusting unit 24-3 of the downstream stage, the resource adjusting unit 24-2 transmits a throughput control cancellation request to the resource adjusting unit 24-1 of the upstream stage (step S208). In response, the resource adjusting unit 24-1 performs a throughput control cancellation process (step S209). The throughput control cancellation process is explained later.

The resource increase process ends here.

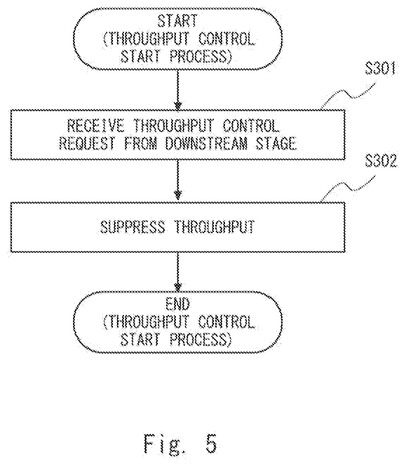

Next, an example of the throughput control start process of step S202 of FIG. 4 is explained with reference to FIG. 5. Hereinafter, an example of the throughput control start process is explained that is performed in a case where an overload occurs in the processing unit 10-2.

As explained in step S201 of FIG. 4, in a case where an overload occurs in the processing unit 10-2, the throughput control request is transmitted from the resource adjusting unit 24-2 to the resource adjusting unit 24-1.

Therefore, as illustrated in FIG. 5, the resource adjusting unit 24-1 receives a throughput control request from the resource adjusting unit 24-2 of the downstream stage (step S301).

Next, the resource adjusting unit 24-1 starts to suppress the throughput of the processing unit 10-1 by controlling the resource control unit 23-1 (step S302). For example, the resource adjusting unit 24-1 decreases the process speed of the processing unit 10-1.

The throughput control start process ends here.

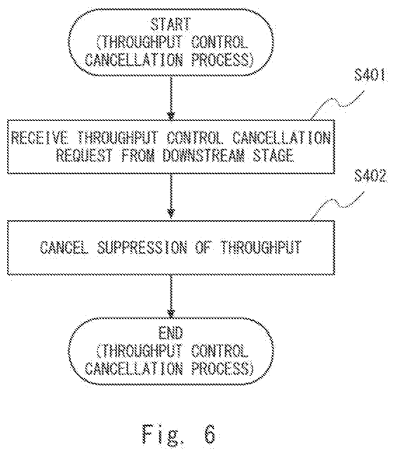

Next, an example of the throughput control cancellation process of step S209 of FIG. 4 is explained with reference to FIG. 6. Hereinafter, an example of the throughput control cancellation process is explained that is performed in a case where an overload occurs in the processing unit 10-2.

As explained in step S208 of FIG. 4, in a case where an overload occurs in the processing unit 10-2 and thereafter the increase of the resource of the processing unit 10-2 is completed or the increase of the resource of the processing unit 10-2 is completed and a resource increase completion notification has been received from the resource adjusting unit 24-3 of the downstream stage, the resource adjusting unit 24-2 transmits a throughput control cancellation request to the resource adjusting unit 24-1.

Therefore, as illustrated in FIG. 6, the resource adjusting unit 24-1 receives the throughput control cancellation request from the resource adjusting unit 24-2 of the downstream stage (step S401).

Next, the resource adjusting unit 24-1 cancels the suppression of the throughput of the processing unit 10-1 by controlling the resource control unit 23-1 (step S402). For example, the resource adjusting unit 24-1 returns the process speed of the processing unit 10-1 to the default process speed.

The throughput control cancellation process ends here.

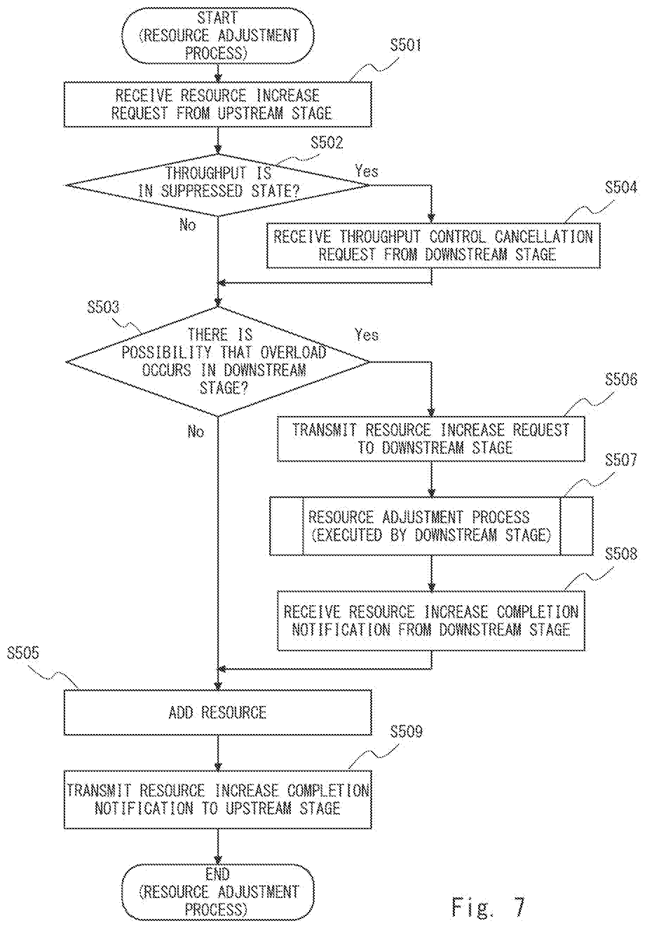

Next, an example of the resource adjustment process of step S206 of FIG. 4 is explained with reference to FIG. 7. Hereinafter, an example of a resource adjustment process is explained that is performed in a case where an overload occurs in the processing unit 10-2.

As explained in step S205 of FIG. 4, in a case where an overload occurs in the processing unit 10-2 and there is a possibility that an overload occurs in the processing unit 10-3, the resource adjusting unit 24-2 transmits a resource increase request to the resource adjusting unit 24-3.

Therefore, as illustrated in FIG. 7, the resource adjusting unit 24-3 receives a resource increase request from the resource adjusting unit 24-2 of the upstream stage (step S501).

Next, the resource adjusting unit 24-3 determines whether the throughput of the processing unit 10-3 is in a suppressed state (i.e., whether the throughput of the processing unit 10-3 is in a throughput control state) (step S502).

In step S502, in a case where the throughput of the processing unit 10-3 is not in a suppressed state (No in step S502), the resource adjusting unit 24-3 determines whether there is a possibility that an overload occurs in the processing unit 10-4 of the downstream stage by increasing the resource of the processing unit 10-3 (step S503).

In contrast, in step S502, in a case where the throughput of the processing unit 10-3 is in a suppressed state (Yes in step S502), the resource adjusting unit 24-3 in on standby until the resource adjusting unit 24-3 receives a throughput control cancellation request from the resource adjusting unit 24-4 of the downstream stage (step S504). In a case where the resource adjusting unit 24-3 receives the throughput control cancellation request from the resource adjusting unit 24-4 of the downstream stage, the resource adjusting unit 24-3 cancels the suppression of the throughput of the processing unit 10-3 by controlling the resource control unit 23-3. Subsequently, the resource adjusting unit 24-3 determines whether there is a possibility that an overload occurs in the processing unit 10-4 of the downstream stage by increasing the resource of the processing unit 10-3 (step S503). However, the example embodiment is not limited thereto, and the resource adjusting unit 24-3 may determine whether there is a possibility that an overload occurs in the processing unit 10-4 of the downstream stage, without waiting for the throughput control cancellation request from the resource adjusting unit 24-4 of the downstream stage.

In step S503, in a case where there is no possibility that an overload occurs in the processing unit 10-4 of the downstream stage (No in step S503), the resource adjusting unit 24-3 starts to increase the resource of the processing unit 10-3 by controlling the resource control unit 23-3 (step S505).

In contrast, in step S503, in a case where there is a possibility that an overload occurs in the processing unit 10-4 of the downstream stage (Yes in step S503), the resource adjusting unit 24-3 transmits a resource increase request to the resource adjusting unit 24-4 of the downstream stage (step S506). In response, the resource adjusting unit 24-4 performs a resource adjustment process (step S507). Thereafter, the resource adjusting unit 24-3 in on standby until the resource adjusting unit 24-3 receives a resource increase completion notification from the resource adjusting unit 24-4 of the downstream stage (step S508). When the resource adjusting unit 24-3 receives the resource increase completion notification from the resource adjusting unit 24-4 of the downstream stage, the resource adjusting unit 24-3 starts to increase the resource of the processing unit 10-3 by controlling the resource control unit 23-3 (step S505). However, the example embodiment is not limited thereto, and the resource adjusting unit 24-3 may start the resource of the processing unit 10-3 without waiting for the resource increase completion notification from the resource adjusting unit 24-4 of the downstream stage.

In a case where the increase of the resource of the processing unit 10-3 is completed or in a case where the increase of the resource of the processing unit 10-3 is completed and the resource adjusting unit 24-3 has received the resource increase completion notification has been received from the resource adjusting unit 24-4 of the downstream stage, the resource adjusting unit 24-3 transmits the resource increase completion notification to the resource adjusting unit 24-2 of the upstream stage (step S509).

The resource adjustment process ends here.

As described above, with the load balancing system 1A according to the present example embodiment, in a case where an occurrence of an overload has been detected in the processing unit 10 of the target stage, the resource of the processing unit 10 of the target stage starts to be increased. Furthermore, in a case where there is a possibility that an overload occurs in the processing unit 10 of the downstream stage due to addition of a resource of the processing unit 10 of the target stage, the resource of the processing unit 10 of the downstream stage also starts to be increased. Then, the throughput of the processing unit 10 of the upstream stage is suppressed until the increase of the resource of the processing unit 10 of the target stage is completed or the increase of the resource of the processing units 10 of the target stage and the downstream stage is completed.

Accordingly, in a case where an overload occurs in the processing unit 10 of the target stage, scale-out of the resource of the processing unit 10 of the target stage can be achieved without causing an overload in the processing unit 10 of the downstream stage.

Furthermore, even when the resource of the processing unit 10 of the target stage is scaled out, loose coupling of the processing units 10 of the target stage, the upstream stage, and the downstream stage can be maintained, and therefore, the range of system that is to be changed due to scale-out can be kept to a minimum.

### Specific Example of Example Embodiment

Next, a specific example of the present example embodiment is explained. In this case, a specific example in a case where the present example embodiment is applied to a face analysis is explained.

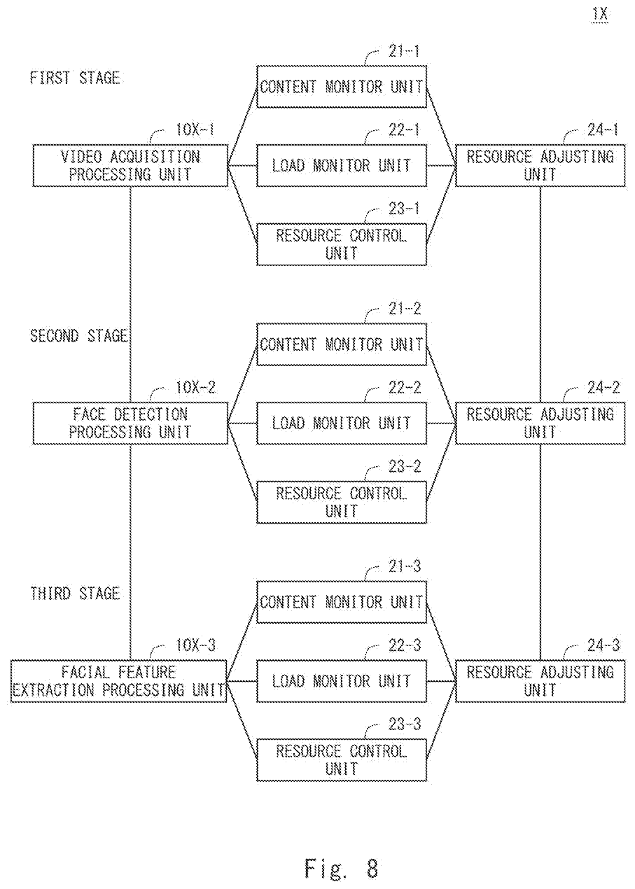

First, an example of configuration of a load balancing system 1X according to a specific example of the present example embodiment is explained with reference to FIG. 8.

As illustrated in FIG. 8, the load balancing system 1X according to a specific example of the present example embodiment is different from the configuration of FIG. 3 in that the load balancing system 1X has three stages of processing and that a video acquisition processing unit 10X-1, a face detection processing unit 10X-2, and a facial feature extraction processing unit 10X-3 are provided as specific examples of the processing units 10-1 to 10-3.

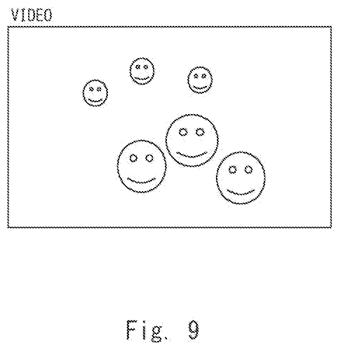

The video acquisition processing unit 10X-1 acquires a video (video frame). FIG. 9 illustrates an example of video acquired by the video acquisition processing unit 10X-1.

The face detection processing unit 10X-2 detects a face from the video acquired by the video acquisition processing unit 10X-1.

The facial feature extraction processing unit 10X-3 extracts a facial feature from the face detected by the face detection processing unit 10X-2.

The processing loads of the face detection processing unit 10X-2 and the facial feature extraction processing unit 10X-3 change according to the number of faces included in the video acquired by the video acquisition processing unit 10X-1.

For example, the load balancing system 1X according to the specific example of the present example embodiment generally performs the following operation, in a case where an overload occurs in the face detection processing unit 10X-2 due to an increase in the number of faces included in the video.

First, the resource of the face detection processing unit 10X-2 starts to be increased. In the specific example of the present example embodiment, the resource is the number of processes, the number of virtual machines (VMs), and the like. Furthermore, when there is a possibility that an overload occurs the facial feature extraction processing unit 10X-3 due to addition of the resource of the face detection processing unit 10X-2, the resource of the facial feature extraction processing unit 10X-3 also starts to increase.

Then, the throughput of the video acquisition processing unit 10X-1 is suppressed until the increase of the resource of the face detection processing unit 10X-2 is completed or the increase of the resources of the face detection processing unit 10X-2 and the facial feature extraction processing unit 10X-3 is completed. For example, the process speed (frames per second, FPS) of the video acquisition processing unit 10X-1 is decreased.

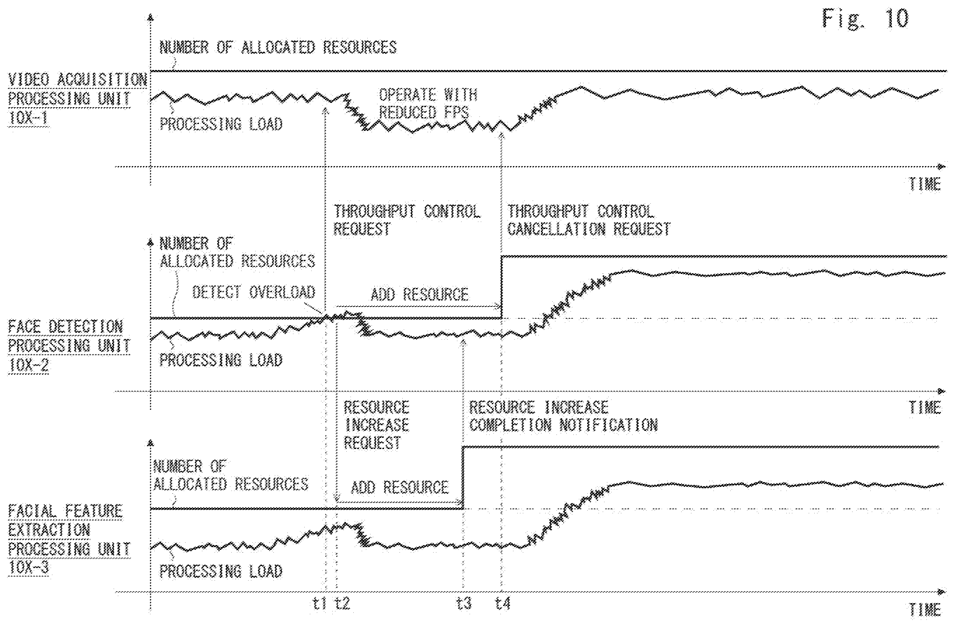

Next, an example of detailed operation of the load balancing system 1X according to the specific example of the present example embodiment is explained with reference to FIG. 10. FIG. 10 illustrates an example of temporal change of the number of allocated resources allocated to each of the processing units 10 and the processing load of each of the processing units 10, for each of the video acquisition processing unit 10X-1, the face detection processing unit 10X-2, and the facial feature extraction processing unit 10X-3. FIG. 10 illustrates an example of a case where an overload occurs in the face detection processing unit 10X-2.

As illustrated in FIG. 10, at a time t1, it is assumed that the resource adjusting unit 24-2 detects an occurrence of an overload in the face detection processing unit 10X-2. Then, the resource adjusting unit 24-2 transmits a throughput control request to the resource adjusting unit 24-1 of the upstream stage. In response, the resource adjusting unit 24-1 starts to suppress the throughput of the video acquisition processing unit 10X-1 by controlling the resource control unit 23-1. In this case, the resource adjusting unit 24-1 operates by reducing the FPS of the video acquisition processing unit 10X-1.

Next, at a time t2, the resource adjusting unit 24-2 starts to increase the resource of the face detection processing unit 10X-2 by controlling the resource control unit 23-2. In this case, the resource adjusting unit 24-2 determines that there is a possibility that an overload occurs in the facial feature extraction processing unit 10X-3 of the downstream stage by increasing the resource of the face detection processing unit 10X-2, and transmits a resource increase request to the resource adjusting unit 24-3 of the downstream stage. In response, the resource adjusting unit 24-3 starts to increase the resource of the facial feature extraction processing unit 10X-3 by controlling the resource control unit 23-3.

Next, at a time t3, when the increase of the resource of the facial feature extraction processing unit 10X-3 is completed, the resource adjusting unit 24-3 transmits a resource increase completion notification to the resource adjusting unit 24-2.

Next, at a time t4, the increase of the resource of the face detection processing unit 10X-2 is completed. At this point in time, the resource adjusting unit 24-2 has already received the resource increase completion notification from the resource adjusting unit 24-3. Therefore, the resource adjusting unit 24-2 transmits a throughput control cancellation request to the resource adjusting unit 24-1 of the upstream stage. In response, the resource adjusting unit 24-1 cancels the suppression of the throughput of the video acquisition processing unit 10X-1 by controlling the resource control unit 23-1. In this case, the resource adjusting unit 24-1 returns the FPS of the video acquisition processing unit 10X-1 to the default FPS.

In the example of FIG. 10, the suppression of the throughput of the video acquisition processing unit 10X-1 is started before the resources of the face detection processing unit 10X-2 and the facial feature extraction processing unit 10X-3 start to be increased, but the example embodiment is not limited thereto. For example, the increase of the resources of the face detection processing unit 10X-2 and the facial feature extraction processing unit 10X-3 and the suppression of the throughput of the video acquisition processing unit 10X-1 may be started at the same time. Alternatively, after the resources of the face detection processing unit 10X-2 and the facial feature extraction processing unit 10X-3 start to be increased, the suppression of the throughput of the video acquisition processing unit 10X-1 may be started.

Next, an example of specific operation of the content monitor unit 21, the load monitor unit 22, and the resource adjusting unit 24 according to the specific example of the present example embodiment is explained.

First, a specific example of an operation in which the content monitor unit 21 monitors the processing content of the processing unit 10 of the self-stage is explained.

As described above, the content monitor unit 21 monitors the processing content of the processing unit 10 of the self-stage.

Further, the content monitor unit 21 calculates a scale value indicative of an actual result of processing performed by the processing unit 10 of the self-stage on the basis of the processing content of the processing unit 10 of the self-stage.

For example, the content monitor unit 21-2 corresponding to the face detection processing unit 10X-2 monitors, as the processing content of the face detection processing unit 10X-2, the number of detected faces indicative of the number of faces detected from a video acquired by the video acquisition processing unit 10X-1. Furthermore, the content monitor unit 21-2 stores content history information indicative of a history of the number of faces detected by the face detection processing unit 10X-2. Table 1 illustrates an example of the content history information held by the content monitor unit 21-2.

TABLE 1

| Time | The number of detected faces |
|---|---|
| 2019/07/31T12:11:33:213 | 10 |
| 2019/07/31T12:11:33:113 | 9 |
| . | . |
| . | . |
| . | . |

The content history information of Table 1 is information in which a time and the number of faces detected at that time are associated with each other.

In this example, the scale value of the face detection processing unit 10X-2 is adopted as the number of detected faces.

Furthermore, the content monitor unit 21-2 calculates an average value of the numbers of detected faces, as an average value of the scale value of the face detection processing unit 10X-2 in a most recent unit time (hereinafter referred to as m seconds).

For example, where m is 1, the content monitor unit 21-2 extracts the number of detected faces from a row within one second with reference to the latest value of the time from among the rows of the Table 1. Then, the content monitor unit 21-2 calculates the average value of number of detected faces that have been extracted, as described below.

Scale=average (10+9+)=10

In this example, the average value of the scale value of the face detection processing unit 10X-2 in the last one second is “10”.

Furthermore, the content monitor unit 21-3 corresponding to the facial feature extraction processing unit 10X-3 monitors: as the processing content of the facial feature extraction processing unit 10X-3, the number of feature extraction processes indicative of the number of times an attempt is made to extract a facial feature from a face detected by the face detection processing unit 10X-2 (i.e., the number of faces from which facial features are attempted to be extracted); and the number of successful feature extractions indicative of the number of times a facial feature is successfully extracted (i.e., the number of faces from which facial features have been successfully extracted). In addition, the content monitor unit 21-3 stores content history information indicative of a history of the number of feature extraction processes and the number of successful feature extractions of the facial feature extraction processing unit 10X-3. Table 2 illustrates an example of content history information stored in the content monitor unit 21-3.

TABLE 2

| | | the number of |
|---|---|---|
| | the number of feature | successful feature |
| Time | extraction processes | extractions |
| 2019/07/31T12:11:33.213 | 100 | 83 |
| 2019/07/31T12:11:33.113 | 90 | 80 |
| . | . | . |
| . | . | . |
| . | . | . |

The content history information of the Table 2 is information in which a time and the number of feature extraction processes and the number of successful feature extractions at that time are associated with each other.

In this example, the scale value of the facial feature extraction processing unit 10X-3 is assumed to be a feature extraction success rate indicative of a success rate at which facial features are successfully extracted.

Then, the content monitor unit 21-3 calculates an average value of the feature extraction success rate, as an average value of the scale value of the facial feature extraction processing unit 10X-3 in the most recent m seconds.

For example, in a case where m is 1, the content monitor unit 21-3 extracts the number of feature extraction processes and the number of successful feature extractions from a row within one second with reference to the latest value of the time from among the rows of the Table 1. Then, the content monitor unit 21-3 calculates an average value of the numbers of feature extraction processes and an average value of the numbers of successful feature extractions that have been extracted, and calculates a ratio of the average values thereof, as described below.

Scale=average (100+90+. . . )/average (83+80+. . . )=0.9

In this example, the average value of the scale value of the facial feature extraction processing unit 10X-3 in the last one second is “0.9”.

Next, a specific example of an operation in which the load monitor unit 22 monitors the processing load of the processing unit 10 of the self-stage is explained.

As described above, the load monitor unit 22 monitors the processing load of the processing unit 10 of the self-stage.

Specifically, the load monitor unit 22 monitors, as the processing load of the processing unit 10 of the self-stage, the number of waiting processes indicative of the number of process targets that are waiting for the processing of the processing unit 10 of the self-stage; and the number of processes per second indicative of the number of process targets processed in one second by the processing unit 10 of the self-stage.

For example, the load monitor unit 22-2 of the face detection processing unit 10X-2 monitors, as the number of waiting processes of the face detection processing unit 10X-2, the number of video frames waiting for the processing of the face detection processing unit 10X-2 from among the video frames acquired by the video acquisition processing unit 10X-1. Furthermore, the load monitor unit 22-2 monitors, as the number of processes per second of the face detection processing unit 10X-2, the number of video frames processed per second by the face detection processing unit 10X-2. Still furthermore, the load monitor unit 22-2 stores load history information indicative of a history of the number of waiting processes of the face detection processing unit 10X-2 and the number of processes per second. Table 3 illustrates an example of load history information stored by the load monitor unit 22-2.

TABLE 3

| | The number of waiting | The number of |
|---|---|---|
| Time | processes | processes per second |
| 2019/07/31T12:11:33 | 10 | 30 |
| 2019/07/31T12:11:34 | 4 | 33 |
| . | . | . |
| . | . | . |
| . | . | . |

The load history information of the Table 3 is information in which a time and the number of waiting processes and the number of processes per second at that time are associated with each other.

The load monitor unit 22-2 calculates the average value of the numbers of waiting processes of the face detection processing unit 10X-2 in the most recent m seconds, and calculates a maximum value of the number of processes per second of the face detection processing unit 10X-2 in the most recent m seconds.

For example, in a case where m is 1, the load monitor unit 22-2 extracts the number of waiting processes and the number of processes per second from a row within one second with reference to the latest value of the time from among the rows of the Table 1. Then, the load monitor unit 22-2 calculates the average value of the numbers of waiting processes that have been extracted, and calculates the maximum value of the number of processes per second that have been extracted, as described below.

The number of waiting processes=average (10+4+. . . )=7

The number of processes per second=max (30+33+. . . )=33

In this example, the average value of the numbers of waiting processes of the face detection processing unit 10X-2 in the last one second is “7”, and the maximum value of the number of processes per second is “33”.

Furthermore, the load monitor unit 22-3 corresponding to the facial feature extraction processing unit 10X-3 monitors, as the number of waiting processes of the facial feature extraction processing unit 10X-3, the number of faces waiting for the processing of the facial feature extraction processing unit 10X-3 from among the faces detected by the face detection processing unit 10X-2. The load monitor unit 22-3 monitors the number of faces processed per second by the facial feature extraction processing unit 10X-3, as the number of processes per second of the facial feature extraction processing unit 10X-3. Still furthermore, the load monitor unit 22-3 stores load history information indicative of a history of the number of waiting processes and the number of processes per second of the facial feature extraction processing unit 10X-3. Table 4 illustrates an example of load history information stored by the load monitor unit 22-3.

TABLE 4

| | The number of waiting | The number of |
|---|---|---|
| Time | processes | processes per second |
| 2019/07/31T12:11:33 | 120 | 43 |
| 2019/07/31T12:11:34 | 110 | 22 |
| . | . | . |
| . | . | . |
| . | . | . |

The load history information of the Table 4 is information in which a time and the number of waiting processes and the number of processes per second at that time are associated with each other.

The load monitor unit 22-3 calculates the average value of the numbers of waiting processes of the facial feature extraction processing unit 10X-3 in the most recent m seconds, and calculates the maximum value of the number of processes per second of the facial feature extraction processing unit 10X-3 in the most recent m seconds.

For example, in a case where m is 1, the load monitor unit 22-3 extracts the number of waiting processes and the number of processes per second from a row within one second with reference to the latest value of the time from among the rows of the Table 1. Then, the load monitor unit 22-3 calculates the average value of the numbers of waiting processes that have been extracted, and calculates the maximum value of the number of processes per second that have been extracted, as described below.

The number of waiting processes=average (120+110+. . . )=100

The number of processes per second=max (43+22+. . . )=43

In this example, the average value of the numbers of waiting processes of the facial feature extraction processing unit 10X-3 in the last one second is “100”, and the maximum value of the number of processes per second is “43”.

Next, a specific example of an operation in which the resource adjusting unit 24 detects an overload in the processing unit 10 of the self-stage is explained.

As described above, the resource adjusting unit 24 detects whether an overload occurs in the processing unit 10 of the self-stage, on the basis of the processing load of the processing unit 10 of the self-stage.

For example, the resource adjusting unit 24 acquires, as the processing load of the processing unit 10 of the self-stage, the average value of the numbers of waiting processes in the most recent m seconds, calculated by the load monitor unit 22 of the self-stage. Then, in a case where the average value of the numbers of waiting processes in the most recent m seconds is more than a threshold value, the resource adjusting unit 24 detects an occurrence of an overload in the processing unit 10 of the self-stage.

Alternatively, the resource adjusting unit 24 acquires, as the processing load of the processing unit 10 of the self-stage, the maximum value of the number of processes per second in the most recent m seconds, calculated by the load monitor unit 22 of the self-stage. Then, in a case where the maximum value of the number of processes per second in the most recent m seconds exceeds a threshold value, the resource adjusting unit 24 detects an occurrence of an overload in the processing unit 10 of the self-stage. At this occasion, the resource adjusting unit 24 can find the upper limit value of the number of processes per second of the processing unit 10 of the self-stage on the basis of the number of allocated resources allocated to the processing unit 10 of the self-stage. Therefore, the above-described threshold value can be set to, for example, a predetermined ratio of the upper limit value of the number of processes per second (for example, 80%).

Next, a specific example of an operation in which the resource adjusting unit 24 determines whether there is a possibility that an overload occurs in the processing unit 10 of the downstream stage is explained.

As described above, the resource adjusting unit 24 determines whether there is a possibility that an overload occurs in the processing unit 10 of the downstream stage on the basis of the processing content and the processing load of the processing unit 10 of the self-stage and the processing load of the processing unit 10 of the downstream stage.

More specifically, the resource adjusting unit 24 calculates a load expectation value indicative of a load that the processing unit 10 of the downstream stage is expected to have, on the basis of the processing content and the processing load of the processing unit 10 of the self-stage. Then, the resource adjusting unit 24 determines that there is a possibility that an overload occurs in the processing unit 10 of the downstream stage, in a case where the load expectation value of the processing unit 10 of the downstream stage exceeds the processing load of the processing unit 10 of the downstream stage.

At this occasion, the resource adjusting unit 24 acquires, as the processing load of the processing unit 10 of the self-stage, the average value of the numbers of waiting processes in the most recent m seconds, calculated by the load monitor unit 22 of the self-stage. Furthermore, the resource adjusting unit 24 acquires, as the processing content of the processing unit 10 of the self-stage, the average value of the scale values in the most recent m seconds, calculated by the content monitor unit 21 of the self-stage. Still furthermore, the resource adjusting unit 24 acquires, as the processing load of the processing unit 10 of the downstream stage, the maximum value of the number of processes per second in the most recent m seconds, calculated by the load monitor unit 22 of the downstream stage.

Then, the resource adjusting unit 24 calculates the load expectation value of the processing unit 10 of the downstream stage by multiplying the average value of the numbers of waiting processes of the processing unit 10 of the self-stage in the most recent m seconds by the average value of the scale values of the processing unit 10 of the self-stage in the most recent m seconds. Then, the resource adjusting unit 24 determines that there is a possibility that an overload occurs in the processing unit 10 of the downstream stage, in a case where the load expectation value of the processing unit 10 of the downstream stage exceeds the maximum value of the number of processes per second of the processing unit 10 of the downstream stage in the most recent m seconds.

For example, the resource adjusting unit 24-2 corresponding to the face detection processing unit 10X-2 calculates a load expectation value of the facial feature extraction processing unit 10X-3 of the downstream stage, as described below.

The load expectation value of the facial feature extraction processing unit 10X-3 of the downstream stage

=the average value of the numbers of waiting processes of the face detection processing unit 10X-2 in the most recent m seconds×the average value of the scale values of the face detection processing unit 10X-2 in the most recent m seconds

=the average value of the numbers of waiting processes of the face detection processing unit 10X-2 in the most recent m seconds×the average values of the numbers of faces detected by the face detection processing unit 10X-2 in the most recent m seconds.

In the example of the Table 1 and the Table 3, in a case where m is 1, the average value of the numbers of waiting processes of the face detection processing unit 10X-2 in the last one second is “10”, the average value of the numbers of detected faces is “7”.

Therefore, the resource adjusting unit 24-2 calculates a load expectation value “70(=10×7)” of the facial feature extraction processing unit 10X-3 of the downstream stage.

Also, in the example of the Table 4, in a case where m is 1, the maximum value of the number of processes per second of the facial feature extraction processing unit 10X-3 of the downstream stage in the last one second is “43”.

Accordingly, the resource adjusting unit 24-2 compares the load expectation value “70” of the facial feature extraction processing unit 10X-3 of the downstream stage and the maximum value “43” of the numbers of processes per second of the facial feature extraction processing unit 10X-3 of the downstream stage. As a result, the load expectation value “70” of the facial feature extraction processing unit 10X-3 of the downstream stage exceeds the maximum value “43” of the numbers of processes per second of the facial feature extraction processing unit 10X-3 of the downstream stage.

Therefore, the resource adjusting unit 24-2 determines that there is a possibility that an overload occurs in the facial feature extraction processing unit 10X-3 of the downstream stage.

As described above, with the load balancing system 1X according to the specific example of the present example embodiment, in a case where an occurrence of an overload has been detected in the face detection processing unit 10X-2, the resource of the face detection processing unit 10X-2 starts to be increased. Furthermore, in a case where there is a possibility that an overload occurs in the facial feature extraction processing unit 10X-3 of the downstream stage due to addition of the resource of the face detection processing unit 10X-2, the resource of the facial feature extraction processing unit 10X-3 of the downstream stage also starts to be increased. Still furthermore, until the increase of the resource of the facial feature extraction processing unit 10X-3 of the face detection processing unit 10X-2 is completed, or until the increase of the resources of the face detection processing unit 10X-2 and the facial feature extraction processing unit 10X-3 of the downstream stage is completed, the throughput of the video acquisition processing unit 10X-1 of the upstream stage is suppressed.

Therefore, in a case where an overload occurs in the face detection processing unit 10X-2, scale-out of the resource of the face detection processing unit 10X-2 can be achieved without causing an overload in the facial feature extraction processing unit 10X-3 of the downstream stage.

Furthermore, even when the resource of the face detection processing unit 10X-2 is scaled out, loose coupling of the video acquisition processing unit 10X-1, the face detection processing unit 10X-2, and the facial feature extraction processing unit 10X-3 can be maintained, and therefore, the range of system that is to be changed due to scale-out can be kept to a minimum.

### Other Specific Examples of Example Embodiment

In the above explanation, a specific example in which the present example embodiment is applied to the face analysis has been explained, but the example embodiment is not limited thereto.

For example, the present example embodiment can also be applied to the case where the analysis target is not a face but is a person or an object. In a case where the analysis target is a person or an object, the face detection processing unit 10X-2 may be replaced with a detection processing unit configured to detect a person or an object from a video acquired by the video acquisition processing unit 10X-1. Furthermore, the facial feature extraction processing unit 10X-3 may be replaced with a feature extraction processing unit configured to extract the feature of the person or the object from the person or the object detected by the detection processing unit.

Furthermore, the scale value, the number of waiting processes, and the number of processes per second of the processing unit 10 are determined according to the process type of the processing unit 10, but the example embodiment is not limited thereto.

For example, the scale value of the processing unit 10 may be a number, a size, a position, a direction, an inclination, a speed, a traveling direction, sharpness, and the like of an analysis target such as a face, a person, an object, and the like.

### Hardware Configuration of Example Embodiment

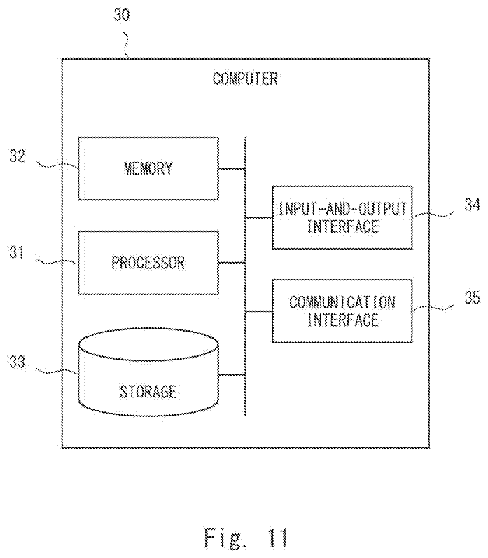

The above-described load balancing systems 1, 1A, and 1X according to the example embodiment may be achieved by a single computer (a load balancing device). Hereinafter, hardware configuration of a computer 30 that implements the above-described load balancing systems 1, 1A, and 1X according to the example embodiment is explained with reference to FIG. 11.

As illustrated in FIG. 11, the above-described load balancing systems 1, 1A, and 1X according to the example embodiment can be achieved by the computer 30. The computer 30 includes a processor 31, a memory 32, a storage 33, an input-and-output interface (an input-and-output I/F) 34, a communication interface (a communication I/F) 35, and the like. The processor 31, the memory 32, the storage 33, the input-and-output interface 34, and the communication interface 35 are connected by a data transmission path for transmitting and receiving data with each other.

The processor 31 is an arithmetic processing unit such as, for example, a CPU (Central Processing Unit), a GPU (Graphics Processing Unit), or the like. For example, the memory 32 is a memory such as a RAM (Random Access Memory), a ROM (Read Only Memory), or the like. The storage 33 is a storage device such as, for example, an HDD (Hard Disk Drive), an SSD (Solid State Drive), a memory card, or the like. Also, the storage 33 may be a memory such as a RAM, a ROM, or the like.

The storage 33 stores programs that achieve the functions of the constituent element of the above-described load balancing systems 1, 1A, and 1X (load balancing programs). The processor 31 achieves the functions of the constituent elements of the above-described load balancing systems 1, 1A, and 1X by executing the programs. In this case, when executing the above-described programs, the processor 31 may execute the programs upon reading the programs to the memory 32, or may execute the programs without reading the programs to the memory 32. The memory 32 and the storage 33 may also achieves the function of storing information and data held by the constituent elements of the above-described load balancing systems 1, 1A, and 1X.

The above-described programs may be stored using various types of non-transitory computer readable media and provided to a computer (including the computer 30). The non-transitory computer readable media include various types of tangible storage media. Examples of non-transitory computer readable media include a magnetic recording medium (for example, a flexible disk, a magnetic tape, and a hard disk drive), a magneto-optical recording medium (for example, a magneto-optical disk), a CD-ROM (Compact Disc-Read Only Memory), a CD-R (CD-Recordable), a CD-R/W (CD-ReWritable), a semiconductor memory (for example, a mask ROM, a PROM (Programmable ROM), an EPROM (Erasable PROM), a flash ROM, and a RAM (Random Access Memory). The programs may be provided to the computer by various types of transitory computer readable media. Examples of transitory computer readable media include electric signals, optical signals, and electromagnetic waves. The transitory computer readable media can provide the programs to the computer via a wired communication path such as an electric wire and an optical fiber or via a wireless communication path.

The input-and-output interface 34 is connected to a display device, an input device, and the like, not illustrated. The display device is an device, such as an LCD (Liquid Crystal Display), a CRT (Cathode Ray Tube) display, or the like, that displays a screen corresponding to drawing data processed by the processor 31. The input device is an device that receives operator's operation inputs, such as, for example, a keyboard, a mouse, a touch sensor, or the like. The display device and the input device may be integrated and achieved as a touch panel.

The communication interface 35 transmits and receives data to and from an external device. For example, the communication interface 35 communicates with an external device via a wired communication path or a wireless communication path.

Although the present disclosure has been described above with reference to the example embodiments, the present disclosure is not limited to the above-described example embodiments. With respect to the configuration and details of the present disclosure, various changes that can be understood by those skilled in the art can be made within the scope of the present disclosure.

Also, some or all of the above-described example embodiments may be described as shown in the following Supplementary Notes, but are not limited thereto.

(Supplementary Note 1)

A load balancing system comprising:

a first processing unit;

a second processing unit configured to process a processing result of the first processing unit;

a third processing unit configured to process a processing result of the second processing unit;

a first resource management unit configured to manage a resource of the first processing unit;

a second resource management unit configured to manage a resource of the second processing unit; and

a third resource management unit configured to manage a resource of the third processing unit, wherein

the second resource management unit detects whether an overload occurs in the second processing unit, and, in a case where the second resource management unit detects that an overload has occurred in the second processing unit, the second resource management unit starts to add a resource of the second processing unit,

in a case where the second resource management unit detects that an overload has occurred in the second processing unit, the third resource management unit starts to add a resource of the third processing unit,

in a case where the second resource management unit detects that an overload has occurred in the second processing unit, the first resource management unit starts to suppress throughput of the first processing unit, and,

in a case where it is completed to add resources of the second processing unit and the third processing unit, the first resource management unit cancels suppression of throughput of the first processing unit.

(Supplementary Note 2)

The load balancing system according to Supplementary Note 1, wherein,

in a case where the second resource management unit detects that an overload has occurred in the second processing unit, the second resource management unit determines whether there is a possibility that an overload occurs in the third processing unit due to addition of a resource of the second processing unit, and,

in a case where the second resource management unit detects that an overload has occurred in the second processing unit, and the second resource management unit determines that there is a possibility that an overload occurs in the third processing unit, the third resource management unit starts to add a resource of the third processing unit.

(Supplementary Note 3)

The load balancing system according to Supplementary Note 2, wherein

the second resource management unit monitors a processing content and a processing load of the second processing unit,

the third resource management unit monitors a processing load of the third processing unit,

the second resource management unit detects whether an overload occurs in the second processing unit, based on a processing load of the second processing unit, and,

in a case where the second resource management unit detects that an overload has occurred in the second processing unit, the second resource management unit determines whether there is a possibility that an overload occurs in the third processing unit, based on a processing content and a processing load of the second processing unit and the processing load of the third processing unit.

(Supplementary Note 4)

The load balancing system according to Supplementary Note 3, wherein, in a case where the second resource management unit detects that an overload has occurred in the second processing unit, the second resource management unit calculates a load expectation value indicating a processing load expected for the third processing unit, based on a processing content and a processing load of the second processing unit, and,

in a case where the load expectation value of the third processing unit exceeds a processing load of the third processing unit, the second resource management unit determines that there is a possibility that an overload occurs in the third processing unit.

(Supplementary Note 5)

The load balancing system according to Supplementary Note 4, wherein

the second resource management unit monitors, as a processing load of the second processing unit, the number of waiting processes indicating the number of processing targets waiting to be processed by the second processing unit, and the number of processes per second indicating the number of processing targets processed per second by the second processing unit,

the second resource management unit calculates an average value of the number of waiting processes of the second processing unit in a most recent unit time, and a maximum value of the number of processes per second of the second processing unit in a most recent unit time, and,

in a case where an average value of the number of waiting processes of the second processing unit or a maximum value of the number of processes per second in a most recent unit time exceeds a threshold value, the second resource management unit detects that an overload has occurred in the second processing unit.

(Supplementary Note 6)

The load balancing system according to Supplementary Note 5, wherein

the second resource management unit calculates an average value of a scale value indicating an actual result of processing of the second processing unit in a most recent unit time, based on a processing content of the second processing unit,

the third resource management unit monitors, as a processing load of the third processing unit, the number of processes per second indicating the number of processing targets processed per second by the third processing unit,

the third resource management unit calculates a maximum value of the number of processes per second processed by the third processing unit in a most recent unit time,

in a case where the second resource management unit detects that an overload has occurred in the second processing unit, the second resource management unit calculates the load expectation value of the third processing unit by multiplying an average value of the number of waiting processes of the second processing unit in a most recent unit time by an average value of the scale value, and,

in a case where the load expectation value of the third processing unit exceeds a maximum value of the number of processes per second of the third processing unit in a most recent unit time, the second resource management unit determines that there is a possibility that an overload occurs in the third processing unit.

(Supplementary Note 7)

The load balancing system according to any one of Supplementary Notes 1 to 6, wherein

the first processing unit is a video acquisition processing unit configured to acquire a video,

the second processing unit is a detection processing unit configured to detect an analysis target from a video acquired by the video acquisition processing unit, and

the third processing unit is a feature extraction processing unit configured to extract a feature from an analysis target detected by the detection processing unit.

(Supplementary Note 8)

A load balancing device comprising:

a first processing unit;

a second processing unit configured to process a processing result of the first processing unit;

a third processing unit configured to process a processing result of the second processing unit;

a first resource management unit configured to manage a resource of the first processing unit;

a second resource management unit configured to manage a resource of the second processing unit; and

a third resource management unit configured to manage a resource of the third processing unit, wherein

the second resource management unit detects whether an overload occurs in the second processing unit, and, in a case where the second resource management unit detects that an overload has occurred in the second processing unit, the second resource management unit starts to add a resource of the second processing unit,

in a case where the second resource management unit detects that an overload has occurred in the second processing unit, the third resource management unit starts to add a resource of the third processing unit,

in a case where the second resource management unit detects that an overload has occurred in the second processing unit, the first resource management unit starts to suppress throughput of the first processing unit, and,

in a case where it is completed to add resources of the second processing unit and the third processing unit, the first resource management unit cancels suppression of throughput of the first processing unit.

(Supplementary Note 9)

The load balancing device according to Supplementary Note 8, wherein,

in a case where the second resource management unit detects that an overload has occurred in the second processing unit, the second resource management unit determines whether there is a possibility that an overload occurs in the third processing unit due to addition of a resource of the second processing unit, and,

in a case where the second resource management unit detects that an overload has occurred in the second processing unit, and the second resource management unit determines that there is a possibility that an overload occurs in the third processing unit, the third resource management unit starts to add a resource of the third processing unit.

(Supplementary Note 10)

A load balancing method being performed by a load balancing device including a first processing unit, a second processing unit configured to process a processing result of the first processing unit, and a third processing unit configured to process a processing result of the second processing unit, the load balancing method comprising:

a first step of detecting whether an overload occurs in the second processing unit;

a second step of, in a case where an occurrence of an overload has been detected in the second processing unit, starting to add resources of the second processing unit and the third processing unit and starting to suppress throughput of the first processing unit, and

a third step of, in a case where it is completed to add resources of the second processing unit and the third processing unit, canceling suppression of throughput of the first processing unit.

(Supplementary Note 11)

The load balancing method according to Supplementary Note 10, further comprising:

a fourth step of, in a case where it is detected that an overload has occurred in the second processing unit, determining whether there is a possibility that an overload occurs in the third processing unit due to addition of a resource of the second processing unit,

wherein the second step starts to, in a case where it is detected that an overload has occurred in the second processing unit, and it is determined that there is a possibility that an overload occurs in the third processing unit, add a resource of the third processing unit.

(Supplementary Note 12)

A non-transitory computer-readable medium storing a load balancing program configured to cause a computer including a first processing unit, a second processing unit configured to process a processing result of the first processing unit, and a third processing unit configured to process a processing result of the second processing unit, to execute:

a first procedure of detecting whether an overload occurs in the second processing unit;

a second procedure of, in a case where an occurrence of an overload has been detected in the second processing unit, starting to add resources of the second processing unit and the third processing unit and starting to suppress throughput of the first processing unit, and

a third procedure of, in a case where it is completed to add resources of the second processing unit and the third processing unit, canceling suppression of throughput of the first processing unit.

(Supplementary Note 13)

The computer-readable medium according to Supplementary Note 12, wherein

the load balancing program causes the computer to further execute a fourth procedure of, in a case where it is detected that an overload has occurred in the second processing unit, determining whether there is a possibility that an overload occurs in the third processing unit due to addition of a resource of the second processing unit, and

the second procedure starts to, in a case where it is detected that an overload has occurred in the second processing unit, and it is determined that there is a possibility that an overload occurs in the third processing unit, add a resource of the third processing unit.

### REFERENCE SIGNS LIST

1, 1A, 1X Load balancing system

10-1 to 10-n Processing unit

10X-1 Video acquisition processing unit

10X-2 Face detection processing unit

10X-3 Facial feature extraction processing unit

20-1 to 20-3 Resource management unit

21-1 to 21-n Content monitor unit

22-1 to 22-n Load monitor unit

23-1 to 23-n Resource control unit

24-1 to 24-n Resource adjusting unit

30 Computer

31 Processor

32 Memory

33 Storage

34 Input-and-output interface

35 Communication interface

What is claimed is:

1. A load balancing system comprising:
a first processing unit;
a second processing unit configured to process a processing result of the first processing unit;
a third processing unit configured to process a processing result of the second processing unit;
a first resource management unit configured to manage a resource of the first processing unit;
a second resource management unit configured to manage a resource of the second processing unit; and
a third resource management unit configured to manage a resource of the third processing unit, wherein
the second resource management unit detects whether an overload occurs in the second processing unit, and, in a case where the second resource management unit detects that an overload has occurred in the second processing unit, the second resource management unit starts to add a resource of the second processing unit,
in a case where the second resource management unit detects that an overload has occurred in the second processing unit, the third resource management unit starts to add a resource of the third processing unit,
in a case where the second resource management unit detects that an overload has occurred in the second processing unit, the first resource management unit starts to suppress throughput of the first processing unit, and,
in a case where it is completed to add resources of the second processing unit and the third processing unit, the first resource management unit cancels suppression of throughput of the first processing unit.

2. The load balancing system according to claim 1, wherein,
in a case where the second resource management unit detects that an overload has occurred in the second processing unit, the second resource management unit determines whether there is a possibility that an overload occurs in the third processing unit due to addition of a resource of the second processing unit, and,
in a case where the second resource management unit detects that an overload has occurred in the second processing unit, and the second resource management unit determines that there is a possibility that an overload occurs in the third processing unit, the third resource management unit starts to add a resource of the third processing unit.

3. The load balancing system according to claim 2, wherein
the second resource management unit monitors a processing content and a processing load of the second processing unit,
the third resource management unit monitors a processing load of the third processing unit,
the second resource management unit detects whether an overload occurs in the second processing unit, based on a processing load of the second processing unit, and,
in a case where the second resource management unit detects that an overload has occurred in the second processing unit, the second resource management unit determines whether there is a possibility that an overload occurs in the third processing unit, based on a processing content and a processing load of the second processing unit and the processing load of the third processing unit.

4. The load balancing system according to claim 3, wherein, in a case where the second resource management unit detects that an overload has occurred in the second processing unit, the second resource management unit calculates a load expectation value indicating a processing load expected for the third processing unit, based on a processing content and a processing load of the second processing unit, and,
in a case where the load expectation value of the third processing unit exceeds a processing load of the third processing unit, the second resource management unit determines that there is a possibility that an overload occurs in the third processing unit.

5. The load balancing system according to claim 4, wherein
the second resource management unit monitors, as a processing load of the second processing unit, the number of waiting processes indicating the number of processing targets waiting to be processed by the second processing unit, and the number of processes per second indicating the number of processing targets processed per second by the second processing unit,
the second resource management unit calculates an average value of the number of waiting processes of the second processing unit in a most recent unit time, and a maximum value of the number of processes per second of the second processing unit in a most recent unit time, and,
in a case where an average value of the number of waiting processes of the second processing unit or a maximum value of the number of processes per second in a most recent unit time exceeds a threshold value, the second resource management unit detects that an overload has occurred in the second processing unit.

6. The load balancing system according to claim 5, wherein
the second resource management unit calculates an average value of a scale value indicating an actual result of processing of the second processing unit in a most recent unit time, based on a processing content of the second processing unit,
the third resource management unit monitors, as a processing load of the third processing unit, the number of processes per second indicating the number of processing targets processed per second by the third processing unit,
the third resource management unit calculates a maximum value of the number of processes per second processed by the third processing unit in a most recent unit time,
in a case where the second resource management unit detects that an overload has occurred in the second processing unit, the second resource management unit calculates the load expectation value of the third processing unit by multiplying an average value of the number of waiting processes of the second processing unit in a most recent unit time by an average value of the scale value, and,
in a case where the load expectation value of the third processing unit exceeds a maximum value of the number of processes per second of the third processing unit in a most recent unit time, the second resource management unit determines that there is a possibility that an overload occurs in the third processing unit.

7. The load balancing system according to claim 1, wherein
the first processing unit is a video acquisition processing unit configured to acquire a video,
the second processing unit is a detection processing unit configured to detect an analysis target from a video acquired by the video acquisition processing unit, and
the third processing unit is a feature extraction processing unit configured to extract a feature from an analysis target detected by the detection processing unit.

8. A load balancing device comprising:
a first processing unit;
a second processing unit configured to process a processing result of the first processing unit;
a third processing unit configured to process a processing result of the second processing unit;
a first resource management unit configured to manage a resource of the first processing unit;
a second resource management unit configured to manage a resource of the second processing unit; and
a third resource management unit configured to manage a resource of the third processing unit, wherein
the second resource management unit detects whether an overload occurs in the second processing unit, and, in a case where the second resource management unit detects that an overload has occurred in the second processing unit, the second resource management unit starts to add a resource of the second processing unit,
in a case where the second resource management unit detects that an overload has occurred in the second processing unit, the third resource management unit starts to add a resource of the third processing unit,
in a case where the second resource management unit detects that an overload has occurred in the second processing unit, the first resource management unit starts to suppress throughput of the first processing unit, and,
in a case where it is completed to add resources of the second processing unit and the third processing unit, the first resource management unit cancels suppression of throughput of the first processing unit.

9. The load balancing device according to claim 8, wherein,
in a case where the second resource management unit detects that an overload has occurred in the second processing unit, the second resource management unit determines whether there is a possibility that an overload occurs in the third processing unit due to addition of a resource of the second processing unit, and,
in a case where the second resource management unit detects that an overload has occurred in the second processing unit, and the second resource management unit determines that there is a possibility that an overload occurs in the third processing unit, the third resource management unit starts to add a resource of the third processing unit.

10. A load balancing method being performed by a load balancing device including a first processing unit, a second processing unit configured to process a processing result of the first processing unit, and a third processing unit configured to process a processing result of the second processing unit, the load balancing method comprising:
a first step of detecting whether an overload occurs in the second processing unit;
a second step of, in a case where an occurrence of an overload has been detected in the second processing unit, starting to add resources of the second processing unit and the third processing unit and starting to suppress throughput of the first processing unit, and
a third step of, in a case where it is completed to add resources of the second processing unit and the third processing unit, canceling suppression of throughput of the first processing unit.

11. The load balancing method according to claim 10, further comprising:
a fourth step of, in a case where it is detected that an overload has occurred in the second processing unit, determining whether there is a possibility that an overload occurs in the third processing unit due to addition of a resource of the second processing unit,
wherein the second step starts to, in a case where it is detected that an overload has occurred in the second processing unit, and it is determined that there is a possibility that an overload occurs in the third processing unit, add a resource of the third processing unit.

12-13. (canceled)
